(19) United States
(12) Patent Application Publication
(10) Pub. No.: US 2007/0283104 A1
(43) Pub. Date: Dec. 6, 2007

(54) Concurrent Hardware Selftest for Central Storage

(75) Inventors: George C. Wellwood, Poughkeepsie, NY (US); Liyong Wang, Wappingers Falls, NY (US); Kevin W. Kark, Poughkeepsie, NY (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/421,167

(22) Filed: May 31, 2006

(51) Int. Cl. G06F 13/00

(52) U.S. Cl. 711/154

(57) ABSTRACT

Disclosed are a concurrent selftest engine and its applications to verify, initialize and scramble the system memory concurrently along with mainline operations. In prior art, memory reconfiguration and initialization can only be done by firmware with a full system shutdown and reboot. The disclosed hardware, working along with firmware, allows us to do comprehensive memory test operations on the extended customer memory area while the customer mainline memory accesses arc running in parallel. The hardware consists of concurrent selftest engines and priority logic. Great flexibility is achieved by the new design because customer-usable memory area can be dynamically allocated, verified and initialized. The system performance is improved by the fact that the selftest is hardware-driven whereas in prior art, the firmware drove the selftest. More comprehensive test patterns can be used to improve system memory RAS as well.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND OF THE INVENTION

1. Field of the Invention

This invention relates to computer system design, and particularly to the system that have large central storage.

2. Description of Background

A method for testing a memory device which has a plurality of memory locations each having a corresponding memory address is known as a memory selftest from U.S. Pat. No. 5,033,048 granted Jul. 16, 1991.

IBM has supplied a memory selftest hardware engine to customers for many years. IBM's hardware which is provided to a customer usually is more than the customer has required at purchase, and the customer generally pays for a configuration of the hardware system in accordance with what he needs based on the real time workloads. The hardware system will release reserved resources on-demand in accordance with such reconfiguration and initialization which has been done by firmware at IML. Memory sub-system resources of a Central Storage belong to this category where the customer is allowed to access only the memory he has purchased. Once the customer's needs expand and he is willing to buy more memory, the memory sub-system can be reconfigured to release more reserved memory for his use. On the other hand, should the customer's needs diminish, the memory sub-system can be reconfigured to have smaller amount of memory available as well.

Once more reserved memory is released to customer, the newly allocated memory needs to be tested via Test Block instruction, fixed by DRAM sparing if necessary, and initialized. Also, once any unused memory is reclaimed back. The data stored in that memory region needs to be erased or perhaps scrambled.

As we have said, in prior IBM machines, such reconfiguration and initialization were done by firmware. It involved a full system shutdown and reboot. Also, the time to test a memory region was really slow due to the fact that it was firmware-driven. Also, the test patterns used for the test were very limited. Those hardware memory selftest engines which existed were only run during system initial machine load (IML) time or to scrub memory during customer operations.

To solve this problem, we have developed and introduced a concurrent memory selftest for use in the IBM z9-109 mainframe system. The current selftest engine, working along with firmware, allows us to do comprehensive memory test operations on the extended customer memory area before it is released to him while the customer mainline memory accesses are running in parallel. The memory about to be allocated could be tested, repaired by sparing if necessary, and cleared. Or the data in the memory just de-allocated can be erased or scrambled. The concurrent selftest activities are totally transparent to any customer operations. Only a fraction of system total memory bandwidth is used to achieve this work. Because the selftest sequences are done by hardware, the time needed to inspect the entire memory region about to be allocated is substantially reduced.

### SUMMARY OF THE INVENTION

The shortcomings of the prior art are overcome and additional advantages are provided through the provision of our new method that concurrently tests and repairs memory. The memory can now be dynamically allocated or de-allocated because of customers' demands, as well as run during system initial machine load (IML) time or to scrub memory during customer operations.

Selftest needs to be performed on newly allocated area to check and initialize the memory. The concurrent selftest activities are totally transparent to any customer operations. Only a fraction of system total memory bandwidth is used to achieve this work.

System and computer program products corresponding to the above-summarized methods are also described and claimed herein.

Additional features and advantages are realized through the techniques of the present invention. Other embodiments and aspects of the invention are described in detail herein and are considered a part of the claimed invention. For a better understanding of the invention with advantages and features, refer to the description and to the drawings.

### Technical Effects

As a result of the summarized invention, technically we have achieved a solution which dynamically checks and repairs the newly allocated memory based on customers' demand. This method improves system performance, as well as the system Reliability, Availability and Serviceability (RAS). The design is flexible and efficient.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates one example of Memory traffic flows in a z9-109 memory controller with memory selftest engines

FIG. 2 illustrates one example of typical z9-109 memory architecture.

FIG. 3 illustrates one example of a block diagram of the concurrent selftest engine

FIG. 4 illustrates one example of a z9-109 system memory configuration

The detailed description explains the preferred embodiments of the invention, together with advantages and features, by way of example with reference to the drawings.

### DETAILED DESCRIPTION OF THE INVENTION

We implement our invention with concurrent selftest hardware provided with the system which contains of two major pieces of hardware: selftest engine and priority logic. When concurrent selftest is needed, the hardware selftest engine is first setup by firmware. Generally, the starting and ending addresses, address mode, and data mode are initialized. After the setup under the firmware the selftest engine will start sending fetch and store commands to the priority logic in the background. The priority logic will take the commands from the selftest engine and regular mainline traffic, prioritize them, and send them sequentially over to the Processor Memory Arrays (PMA) section of the memory sub-system.

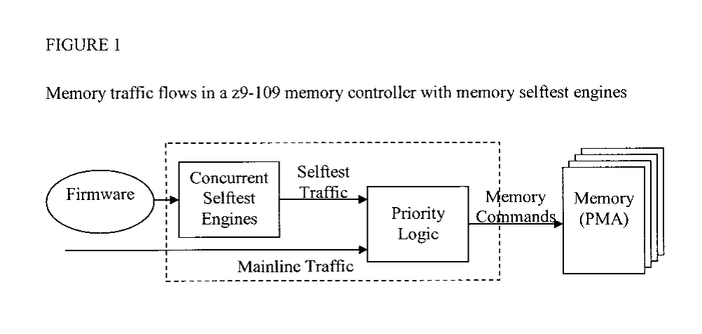

Turning now to the drawings in greater detail, it will be seen that in FIG. 1 there is a system block diagram that shows how the memory traffic is handled.

In the z9-109 implementation, the MSC (Main Storage Controller) chip has an X port and a Y side each independently controlling a PMA. Within the hardware we have provided a plurality of ports for a memory region of the global system storage, each of these ports has a concurrent selftest engine which is assigned to test a memory region within a set of DRAMs on the PMA to which it is assigned. There are X and Y ports of the Controller which operate independently, and the engines in both the X and Y ports can be operating in parallel as well. There are two MSC chips to a node, and both MSC chips in a node can be operating in parallel, as can the 4 nodes in a system. That adds up to 16 selftest engines running allocated to memory regions concurrently to quickly verify the quality of the pre-allocated extended memory. See the illustrations described below with respect to the Figures for the selftest hardware engines in a system.

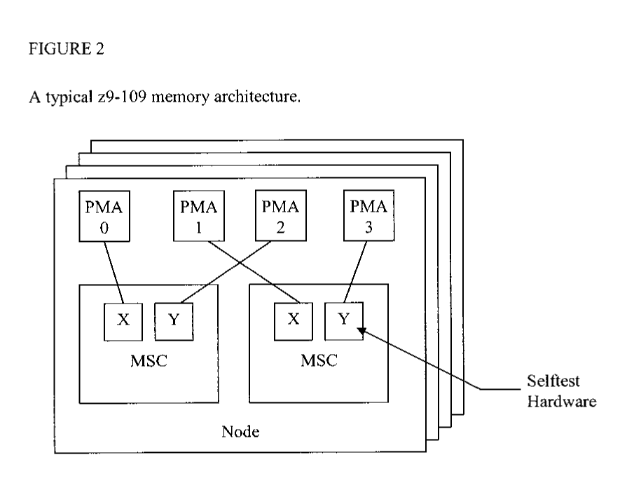

FIG. 2 shows an example of the memory architecture of z9-109 implementation.

Concurrent Selftest Engine

Below are the detailed explanations of each of the components The concurrent selftest engine is the core of the hardware employed to test and repair memory and to dynamically allocate or de-allocate memory regions because of customers' demands. Once setup, it will generate the memory fetch and store commands to the priority logic. For memory stores, the selftest engine can use fixed or random data patterns. For memory fetches, the hardware memory selftest engine (in a manner different from the selftest engine of U.S. Pat. No. 5,003,048) will check the data validity either by bit comparing or by ECC checking, and update the selftest status based on the results.

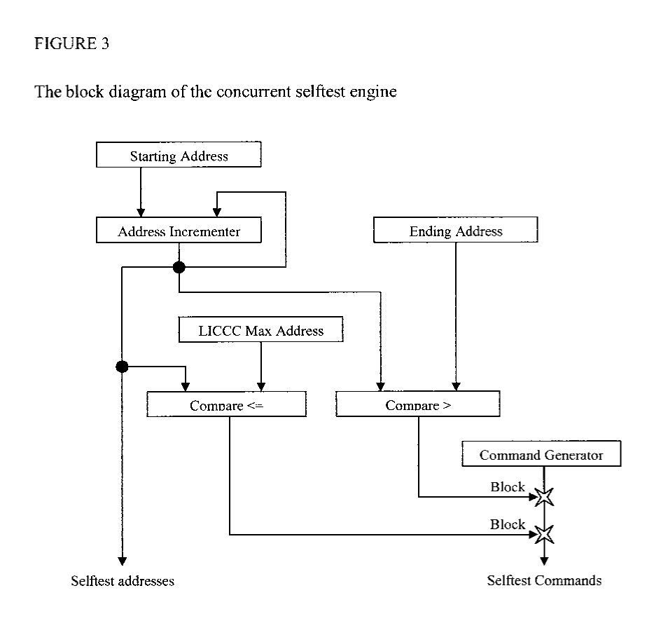

FIG. 3 shows the block diagram of the concurrent selftest engine.

The firmware implements the following setup parameters which are used in a hardware concurrent selftest engine. The settings are divided into 4 categories.

Address Control Parameters

1. Starting Address

It defines starting address of the extended memory region that the concurrent selftest will be working on.

2. Ending Address

It defines ending address of the extended memory region that the hardware concurrent selftest engine will be working on.

4. LICCC (Licensed Internal Code Configuration Control) Address

It defines the upper limit of the customer address space. It is used as a control to prevent any selftest accesses from entering the customer's address range. Any setup error or internal control error results in a specification error status being posted to the firmware.

Data Control Parameters

4. Data Generation Mode

For selftest writes, the firmware setup controls the data and requires it to be either fixed data pattern or random data pattern. In fixed data pattern mode, the data generated will be from Data Pattern Parameter. In random data pattern mode, the data will be calculated by a random data generator.

5. Data ECC Mode: ECC/Compare Mode

The firmware defines the way data is sent to or returned from memory. In ECC mode, the data will be transferred along with an ECC code. On a fetch operation the fetch ECC station will check the ECC results. In compare mode, the data will be transferred as 144 bit data without ECC. On a fetch operation, the data is compared against a known data pattern to verify its validity,

6. Data Pattern

The data control parameter holds the implemented data pattern. It is used in fixed data pattern mode and also used as the starting point by the random data generator in random data mode.

7. Random Data Generation Mask

The random data generation mask is used by the random data generator to generate random data patterns.

Operation Sequence Control Parameters

8. Gap Control

The firmware gap control is used to introduce artificial gaps between the commands that the hardware memory selftest engine sends to memory. This would affect the data bandwidth that the engine uses comparing to the overall memory data bandwidth. This would affect the system performance since the concurrent selftest engine shares the same memory and memory ports with mainline function. In concurrent mode, speed in completing the testing is generally not a factor. Thus, the gap is generally set fairly large to limit the data bandwidth usage.

9. Start/Stop Bits

Start/stop bits are the main switch to turn on/off the selftest engine.

Status and Error Reporting Registers

10. Status Register

A status register stores the current status of the concurrent selftest engine and the overall testing results. Firmware can poll this register periodically to watch the selftest progress and check the overall selftest results.

11. Bit Error Counters

Each data bit has a corresponding bit error counter that keeps track of how many errors have occurred during the memory selftest. During the concurrent selftest in compare mode, should miscompares occur, the selftest engine will increment the count for the corresponding bit. In ECC mode, the counters also increment when data CE is detected.

Priority Logic

The main function of the hardware priority logic is to merge the memory command stream from selftest engine with the mainline memory command stream together. The priority logic can be programmed to treat the selftest commands with normal priority or lower priority.

In normal priority mode, the priority logic will treat both selftest command and mainline command in the same manner. The commands arc basically executed based on the availability of the DRAM banks only. The memory bandwidth used by selftest commands is mainly controlled by the ‘gap control’ parameter of the selftest engine,

In low priority mode, the priority logic will give the selftest command lower weight than the regular mainline commands. The selftest command will only be executed if there are no outstanding mainline commands pending. This will minimize the performance impact that concurrent selftest posts would cause on the mainline memory operations.

The other function that the priority logic provides is by the hardware that handles the memory bank/rank conflicts. Traditionally, all the incoming mainline commands are targeting different memory banks by design. However, we have added memory selftest commands in background could target a memory bank that is currently being used by regular mainline commands. When such a conflict occurs, the priority logic will delay sending out the later coming command until its target memory bank is freed.

Firmware

Firmware is the driving force for the concurrent selftest. Basically, when such selftest is needed, firmware first sets up the selftest engine with parameters detailed in the above section. Once the concurrent selftest is initiated, all the hardware memory selftest engines on each memory port run in parallel. The firmware periodically polls the selftest status. Once all the engines finished the tests on its own memory port, the firmware can retrieve all the error status information out and takes indicated and proper actions based on the results, e.g. sparing the DRAM chips and other operations.

Applications

The central storage regions can be categorized as follow. The selftest engine will mainly work on the inactive regions and the unassigned regions, once the system storage configuration is changed on-demand by the customer.

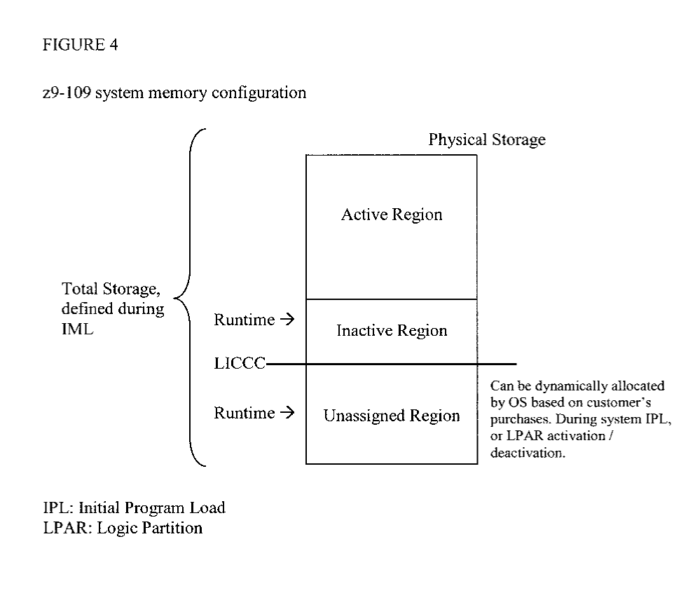

FIG. 4 shows a typical storage configuration of a z9-109 system

The performance gets boosted substantially since the activities are done by hardware and no firmware code is involved during the selftest execution. The concurrent selftest engine can be used for the following scenarios:

1. Concurrently Verify/Test the Newly Allocated Memory Region

(Once the new memory is allocated, the concurrent selftest is performed to verify the memory content has any defects or not. This has performance advantage over the existing implementation.)

2. Concurrently Initialize the Newly Allocated Memory Region per Architecture.

(Once the newly allocated the memory has tested defect-free, the memory needs to be initialized with a certain data pattern before being turned over to customer usage. The data pattern is determined per system architecture.)

3. Concurrently Clear an Unused Memory Region that Application is no Longer Active.

(For data security reason, the concurrent selftest can be used to clear a chunk of memory with a fixed data pattern thus erasing all the leftover customer information.)

4. Concurrently Scramble an Unused Active Memory Region

(This new capability is useful for data security. The concurrent selftest can be used to clear a chunk of memory with a random data pattern thus erasing all the leftover customer information.)

The capabilities of the present invention are and can be implemented in software, firmware and hardware as a combination thereof using the hardware memory selftest engine.

As one example, one or more aspects of the present invention can be included in an article of manufacture (e.g., one or more computer program products) having, for instance, computer usable media for implementing the invention. The media has embodied therein, for instance, computer readable program code means for providing and facilitating the capabilities of the present invention. The article of manufacture can be included as a part of a computer system or sold separately.

Additionally, at least one program storage device readable by a machine, tangibly embodying at least one program of instructions executable by the machine to perform the capabilities of the present invention can be provided.

The flow diagrams depicted herein are just examples. There may be many variations to these diagrams or the steps (or operations) described therein without departing from the spirit of the invention. For instance, the steps may be performed in a differing order, or steps may be added, deleted or modified. These steps can be provided as a service to the customer. All of these variations are considered a part of the claimed invention.

While the preferred embodiment to the invention has been described, it will be understood that those skilled in the art, both now and in the future, may make various improvements and enhancements which fall within the scope of the claims which follow. These claims should be construed to maintain the proper protection for the invention first described.

What is claimed is:

1. A method for testing a computer's memory storage system which has a plurality of memory locations each having a corresponding memory address, comprising the steps of:
employing memory selftest hardware for a memory region of said memory storage system
having a plurality of memory regions and with said memory selftest hardware concurrently verifying and testing a newly allocated memory region while other memory regions of said memory storage system are operating.

2. A method for testing a computer's memory storage system which has a plurality of memory locations each having a corresponding memory address, comprising the steps of:
employing memory selftest hardware for a memory region of said memory storage system having a plurality of memory regions and
with said memory selftest hardware concurrently initializing a newly allocated memory region in accordance with the system architecture.

3. A method for testing a computer's memory storage system which has a plurality of memory locations each having a corresponding memory address, comprising the steps of:
employing memory selftest hardware for a memory region of said memory storage system having a plurality of memory regions and
concurrently clearing an unused memory region of an application is no longer active.

4. A method for testing a computers memory storage system which has a plurality of memory locations each having a corresponding memory address, comprising the steps of:
employing memory selftest hardware for a memory region of said memory storage system having a plurality of memory regions and
concurrently scrambling an unused active memory region.

5. A method for testing a computer's memory storage system according to claim 1 wherein the operations of the memory selftest hardware is controlled by firmware used to setup, control and monitor the progress of concurrent selftest.

6. A method for testing a computer's memory storage system according to claim 1 wherein the memory selftest hardware is part of a computer system having memory selftest hardware that is controlled by firmware and provides memory which is dynamically allocated or de-allocated because of customers' demands, as well as run during system initial machine load (IML) time or to scrub memory during customer operations.

7. A method for testing a computer's memory storage system according to claim 1 wherein the memory selftest hardware is part of a computer system having memory selftest hardware which comprises a selftest engine and priority logic for each memory region of the computer system, and when concurrent selftest is needed, the hardware selftest engine is first setup by firmware by initialization of starting and ending addresses, address mode, and data mode, and then after the setup under the firmware the selftest engine starts sending fetch and store commands to the priority logic in the background wherein the priority logic takes commands from the selftest engine and any regular mainline traffic to prioritize them and send them sequentially over to the memory region's Processor Memory Arrays (PMA) of the memory sub-system.

8. A method for testing a computer's memory storage system according to claim 1 wherein the memory selftest hardware is part of a computer system having memory selftest hardware which comprises a selftest engine and priority logic for each memory region of the computer system, and the computer system provides a main storage controller having an X port and a Y port side each independently controlling a memory region's Processor Memory Arrays (PMA), wherein each of these X and Y ports has a concurrent selftest engine which is assigned to test a memory region within a set of DRAMs on the PMA to which it is assigned and these X and Y ports of the main storage controller which operate independently, and can be operating in parallel as well

9. A method for testing a computer's memory storage system according to claim 1 wherein the memory selftest hardware is part of a computer system having memory selftest hardware which comprises a selftest engine and priority logic for each memory region of the computer system, and the computer system provides a main storage controller having an X port and a Y port side each independently controlling a memory region's Processor Memory Arrays (PMA), and wherein there are two memory storage controllers to a node, and both memory storage controllers in a node can be operating in parallel, as can all nodes in a system.

10. A method for testing a computer's memory storage system according to claim 1 wherein the memory selftest hardware is part of a computer system having memory selftest hardware which comprises a selftest engine and priority logic for each memory region of the computer system, said memory selftest hardware being employed to test and repair memory and to dynamically allocate or de-allocate memory regions because of customers' demands, generating during machine operations memory fetch and store commands to the priority logic.

11. A method for testing a computer's memory storage system according to claim 1 wherein the memory selftest hardware is part of a computer system having memory selftest hardware which comprises a selftest engine and priority logic for each memory region of the computer system, said memory selftest hardware being employed to test and repair memory and to dynamically allocate or de-allocate memory regions because of customers' demands using fixed or random data patterns for memory stores and performing a check of the data validity for a memory region either by bit comparing or by ECC checking, and update the selftest status based on the results.

12. A method for testing a computer's memory storage system according to claim 1 wherein the memory selftest hardware is part of a computer system having memory selftest hardware which comprises a selftest engine and priority logic for each memory region of the computer system, said memory selftest hardware being set by firmware which implements setup parameters which are used in said memory selftest hardware, including parameters for:.
Address control, Data control, Operation sequence control and Status and Error reporting registers.

13. A method for testing a computer's memory storage system according to claim 1 wherein the memory selftest hardware is part of a computer system having memory selftest hardware which comprises a selftest engine and priority logic for each memory region of the computer system, said memory selftest hardware being set by firmware which implements setup parameters which are used in said memory selftest hardware, including parameters for:
Address control, Data control, Operation sequence control and Status and Error reporting registers, and
wherein said Address control parameters include
a. a starting address for the extended memory region that the concurrent selftest will be working on,
b. an ending address of the extended memory region that the hardware concurrent selftest engine will be working on,
c. an upper limit of a customer address space used as a control to prevent any selftest accesses from entering the customer's address range with any setup error or internal control error resulting in a specification error status being posted to the firmware; and,
wherein said Data control parameters include
d. A data generation mode for selftest writes whereby the firmware setup controls the data and requires it to be either fixed data pattern or random data pattern, and under which, in fixed data pattern mode, the data generated will be from a data pattern parameter and in random data pattern mode, the data will be calculated by a random data generator, and
e. a data ECC mode whereby the firmware defines the way data is sent to or returned from memory and wherein the data will be transferred along with an ECC code, and wherein, on a fetch operation a fetch ECC station will check ECC results, and wherein, in a compare mode, the data will be transferred as 144 bit data without ECC and on a fetch operation, the data is compared against a known data pattern to verify its validity, and,
f. a data pattern whereby the data control parameter holds an implemented data pattern used in fixed data pattern mode and also used as the starting point by the random data generator in random data mode, and
g. a random data generation mask used by a random data generator to generate random data patterns, and
wherein said operation sequence control parameters includes:
h. a firmware gap control used to introduce artificial gaps between the commands that the hardware memory selftest engine sends to memory, and
i. start/stop bits used to turn on/off the selftest engine, and
wherein said Status and Error reporting registers include
j. a status register used to store the current status of the memory selftest hardware and the overall testing results and wherein the firmware can poll this register periodically to watch the selftest progress and check the overall selftest results, and
k. bit error counters such that each data bit has a corresponding bit error counter that keeps track of how many errors have occurred during the memory selftest.

14. A method for testing a computer's memory storage system according to claim 1 wherein the memory selftest hardware is part of a computer system having memory selftest hardware which comprises a selftest engine and priority logic for each memory region of the computer system, said priority logic being used to merge a memory command stream from selftest engine with a mainline memory command stream, and being programmable to treat selftest commands with normal priority or lower priority, wherein in normal priority mode, the priority logic will treat both selftest command and mainline command in the same manner, and wherein in low priority mode, the priority logic will give the selftest command lower weight than the regular mainline commands such that the selftest command will only be executed if there are no outstanding mainline commands pending, and wherein in addition the priority logic provides hardware that handles the memory bank/rank conflicts such added memory selftest commands in background could target a memory bank that is currently being used by regular mainline commands whereby when such a conflict occurs, the priority logic will delay sending out a later coming command until its target memory bank is freed.

15. A method for testing a computer's memory storage system according to claim 1 wherein the memory selftest hardware is part of a computer system having memory selftest hardware which comprises a selftest engine and priority logic for each memory region of the computer system and firmware executed when such selftest is needed, said firmware first setting up the selftest engine with parameters for a concurrent selftest, and once the concurrent selftest is initiated, all the memory selftest hardware on each memory port is run in parallel with the memory selftest hardware of other ports, and wherein the firmware periodically polls the selftest status and retrieves, once all the engines finished the tests on its own memory port, all the error status information and takes indicated actions based on the results.

16. A method for testing a computer's memory storage system according to claim 1 wherein the memory selftest hardware is part of a computer system having memory selftest hardware which comprises a selftest engine and priority logic for each memory region of central storage of the computer system, wherein selftest engine will mainly work on the inactive regions and the unassigned regions of central storage, once a system storage configuration is changed on-demand by the customer, and said selftest engine is enabled to be used for:
a. a concurrent verify/test of a newly allocated memory region to verify the memory content has any defects or not, and
b. concurrently initializing the newly allocated memory region after newly allocated memory has tested defect-free with a certain data pattern before being turned over to customer usage, said certain data pattern being determined per system architecture, and
c. concurrently clearing an unused memory region when an application is no longer active with a fixed data pattern thus erasing all leftover customer information in said unused memory region, and
d. concurrently scrambling an unused active memory region for data security to clear a chunk of memory with a random data pattern thus erasing all the leftover customer information.

17. A method for testing a computer's memory storage system according to claim 1 wherein the memory selftest hardware is part of a computer system having memory selftest hardware which comprises a selftest engine and priority logic for each memory region of the computer system and computer usable media for implementing the memory selftest for testing and allocating memory for an application, including computer readable program code for providing and facilitating the verifying and testing of a newly allocated memory region while other memory regions of said memory storage system are operating.

18. A method for testing a computer's memory storage system according to claim 1 wherein the memory selftest hardware set up to perform with said memory selftest hardware a service which tests and repairs memory for said computer system and to dynamically allocate or de-allocate memory regions because of customers' demands for the computer system

19. A method for testing a computer's memory storage system according to claim 1 wherein at least one program storage device readable by a machine, tangibly embodying at least one program of instructions executable by the machine provides instructions for said memory selftest control by hardware.
one or more aspects of the present invention can be included in an article of manufacture (e.g., one or more computer program products) having, for instance, computer usable media for implementing the invention. The media has embodied therein, for instance, computer readable program code means for providing and facilitating the capabilities of the present invention. The article of manufacture can be included as a part of a computer system or sold separately.
Additionally, the capabilities of the present invention can be provided.
